(19) United States
(12) Patent Application Publication
(10) Pub. No.: US 2026/0230610 A1
(43) Pub. Date: Aug. 6, 2026

(54) Methods and Apparatus of Fractional Block Vectors in Intra Block Copy and Intra Template Matching for Video Coding

(71) Applicant: MEDIATEK INC., Hsinchu City (TW)

(72) Inventors: Chen-Yen LAI, Hsinchu City (TW); Man-Shu CHIANG, Hsinchu City (TW); Yu-Cheng LIN, Hsinchu City (TW); Chih-Hsuan LO, Hsinchu City (TW); Ching-Yeh CHEN, Hsinchu City (TW); Tzu-Der CHUANG, Hsinchu City (TW); Yu-Wen HUANG, Hsinchu City (TW); Yi-Wen CHEN, San Jose, CA (US); Chih-Wei HSU, Hsinchu City (TW)

(21) Appl. No.: 19/148,446

(22) PCT Filed: Jan. 18, 2024
(86) PCT No.: PCT/CN2024/073077

§ 371 Date: Jul. 16, 2025

Related U.S. Application Data
(60) Provisional application No. 63/480,330, filed on Jan. 18, 2023.
(60) Provisional application No. 63/497,761, filed on Apr. 24, 2023.

(51) Int. Cl. H04N 19/117; H04N 19/105; H04N 19/176; H04N 19/82

(52) U.S. Cl. CPC H04N 19/117; H04N 19/105; H04N 19/176; H04N 19/82

(57) ABSTRACT

Method and apparatus for video coding using fractional block vectors for IBC and/or IntraTMP. According to the method, when a current BV is a fractional BV, prediction samples of the predictor are generated by applying an interpolation filter to reference samples according to the current BV and the current block location, and wherein if a target reference sample for the interpolation filter is unavailable, a padded or copied sample is used or the current BV is modified so that all the reference samples for the interpolation filter are available. According to another method, a current BV is derived based on a base BV of the current block and an IBC merge mode list, or based on IntraTMP-derived BV of a neighbouring block, wherein the IBC merge mode list or the IntraTMP-derived BV is allowed to use fractional accuracy. A predictor is generated using information comprising according to the current BV.

### CROSS REFERENCE TO RELATED APPLICATIONS

The present invention is a non-Provisional Application of and claims priority to U.S. Provisional Patent Application No. 63/480,330, filed on Jan. 18, 2023 and U.S. Provisional Patent Application No. 63/497,761, filed on Apr. 24, 2023. The U.S. Provisional Patent Applications are hereby incorporated by reference in their entireties.

### FIELD OF THE INVENTION

The present invention relates to video coding system. In particular, the present invention relates to fractional-precision block vectors in intra block copy and intra template matching for a video coding system.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

In the present invention, methods and apparatus to use fractional block vector precision for IBC and/or IntraTMP.

### BRIEF SUMMARY OF THE INVENTION

A method and apparatus for video coding using fractional block vectors for IBC and/or IntraTMP are disclosed. According to the method, input data associated with a current block are received, wherein the input data comprises pixel data to be encoded at an encoder side or data associated with the current block to be decoded at a decoder side, and wherein the current block is coded in IBC (Intra Block Copy) mode. When a current BV (Block Vector) for the current block is a fractional BV, a predictor is generated, wherein prediction samples of the predictor are generated by applying an interpolation filter to reference samples as identified according to the current BV and a location of the current block, and wherein if a target reference sample for the interpolation filter is unavailable, a padded or copied sample is used or the current BV is modified so that all the reference samples for the interpolation filter are available. The current block is encoded or decoded using the predictor.

According to another method, input data associated with a current block are received, wherein the input data comprises pixel data to be encoded at an encoder side or data associated with the current block to be decoded at a decoder side, and wherein the current block is coded in IBC (Intra Block Copy) mode or IntraTMP (Intra Template Matching Prediction) mode. A refined current BV (Block Vector) of current block is derived based on a base BV derived from an IBC merge mode list, or based on a base BV of an IntraTMP coded block, wherein the refined current BV is allowed to use fractional accuracy. A predictor is generated using information comprising the refined current BV. The current block is encoded or decoded using the predictor.

In one embodiment, the IBC merge mode list is associated with IBC MBVD (Merge with BV Difference) mode, IBC CIIP (Combined Intra-Inter Prediction) mode, IBC GPM (Geometric Partition Mode) mode, or IBC LIC (Local Illumination Compensation) mode.

In one embodiment, a high-level syntax is signalled or parsed, wherein high-level syntax indicates whether the fractional accuracy is applied to the IBC, the intraTMP mode or both.

In one embodiment, a finest accuracy of the base BV signalled or parsed corresponds to 1/N-pel luma sample and N is one positive integer. In one embodiment, N corresponds to 1 or 4. In one embodiment, a finest fractional accuracy of the refined BV corresponds to 1/M-pel luma sample and M is one positive integer greater than or equal to N. In one embodiment, M corresponds to 16.

In one embodiment, the base BV in the IBC merge mode list without a delta BV has a higher priority compared with the refined BV with a delta BV derived from the base BV. In one embodiment, multiple BV resolutions or adaptive BV resolutions are applied to the current block, a first flag is signalled or parsed to indicate whether IBC-MBVD is used for the current block and a second flag is signalled or parsed to indicate BV resolutions. In one embodiment, when IBC-MBVD (Merge with BV Difference) is applied to inter-slices or inter-pictures, MBVD derivation method is the same as MMVD (Merge mode with Motion Vector Difference) derivation method. In one embodiment, when IBC-MBVD (Merge with BV Difference) is applied to the current block, only finer MBVD refinement positions are reordered when BV resolution belongs to a finer precision.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates an example of IBC (Intra Block Copy) compensation, where blocks are predicted by corresponding blocks in the same picture.

FIG. 3 illustrates an example of search area used for Intra template matching.

FIG. 4 illustrates an example of use of IntraTMP block vector for IBC block.

FIG. 5 illustrates comparison between the frequency responses of the 12-tap interpolation filters of IBC-MBVD and the VVC interpolation filter all at half-pel phase.

FIG. 6 illustrates the distance offsets from a starting MV in the horizontal and vertical directions according to Merge Mode with MVD (MMVD).

FIG. 7 illustrates a flowchart of an exemplary video coding system that uses fractional block vector precision for IBC and/or IntraTMP according to an embodiment of the present invention.

FIG. 8 illustrates a flowchart of another exemplary video coding system that uses fractional block vector precision for IBC and/or IntraTMP according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

### Intra-Block-Copy (IBC) Mode

Motion Compensation, one of the key technologies in hybrid video coding, explores the pixel correlation between adjacent pictures. It is generally assumed that, in a video sequence, the patterns corresponding to objects or background in a frame are displaced to form corresponding objects in the subsequent frame or correlated with other patterns within the current frame. With the estimation of such displacement (e.g. using block matching techniques), the pattern can be mostly reproduced without the need to re-code the pattern. Similarly, block matching and copy has also been tried to allow selecting the reference block from the same picture as the current block. It was observed to be inefficient when applying this concept to camera captured videos. Part of the reasons is that the textual pattern in a spatial neighbouring area may be similar to the current coding block, but usually with some gradual changes over the space. It is difficult for a block to find an exact match within the same picture in a video captured by a camera. Accordingly, the improvement in coding performance is limited.

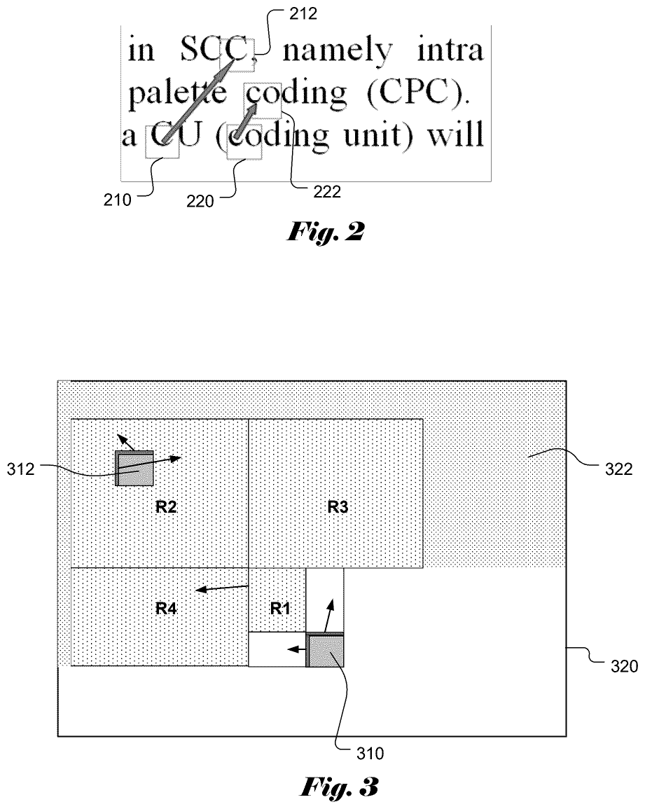

However, the situation for spatial correlation among pixels within the same picture is different for screen contents. For a typical video with texts and graphics, there are usually repetitive patterns within the same picture. Hence, intra (picture) block compensation has been observed to be very effective. A new prediction mode, i.e., the intra block copy (IBC) mode or called current picture referencing (CPR), has been introduced for screen content coding to utilize this characteristic. In the CPR mode, a prediction unit (PU) is predicted from a previously reconstructed block within the same picture. Further, a displacement vector (called block vector or BV) is used to indicate the relative displacement from the position of the current block to that of the reference block. The prediction errors are then coded using transformation, quantization and entropy coding. An example of IBC compensation is illustrated in FIG. 2, where block 212 is a corresponding block for block 210, and block 222 is a corresponding block for block 220. In this technique, the reference samples correspond to the reconstructed samples of the current decoded picture prior to in-loop filter operations, both deblocking and sample adaptive offset (SAO) filters in HEVC.

The very first version of IBC was proposed in JCTVC-M0350 (Budagavi et al., AHG8: Video coding using Intra motion compensation, Joint Collaborative Team on Video Coding (JCT-VC) of ITU-T SG16 WP3 and ISO/IEC JTC 1/SC 29/WG11, 13th Meeting: Incheon, KR, 18-26 Apr. 2013, Document: JCTVC-M0350) to the HEVC Range Extensions (RExt) development. In this version, the IBC compensation was limited to be within a small local area, with only 1-D block vector and only for block size of 2N×2N. Later, a more advanced IBC design has been developed during the standardization of HEVC SCC (Screen Content Coding).

### Intra Template Matching

Intra template matching prediction (IntraTMP) is a special intra prediction mode that copies the best prediction block from the reconstructed part of the current frame, whose L-shaped template matches the current template. For a predefined search range, the encoder searches for the most similar template matched with the current template in a reconstructed part of the current frame and uses the corresponding block as a prediction block. The encoder then signals the usage of this mode, and the same prediction operation is performed at the decoder side.

The prediction signal is generated by matching the L-shaped causal neighbour of the current block with another block in a predefined search area in FIG. 2 consisting of:
R1: current CTU
R2: top-left CTU
R3: above CTU
R4: left CTU

In FIG. 3, the current block 310 in R1 is matched with the corresponding block 312 in R2. The templates for the current block and the matched block are shown as darker-colour L-shaped areas. Area 322 corresponds to reconstructed region in the current picture 320. Sum of absolute differences (SAD) is used as a cost function. Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$SearchRange\_w = a * BlkW ,$$

$$SearchRange\_h = a * BlkH .$$

Where ‘a’ is a constant that controls the gain/complexity trade-off. In practice, ‘a’ is equal to 5.

To speed-up the template matching process, the search range of all search regions is subsampled by a factor of 2. This leads to a reduction of template matching search by 4. After finding the best match, a refinement process is performed. The refinement is done via a second template matching search around the best match with a reduced range. The reduced range is defined as min(BlkW, BlkH)/2.

The Intra template matching tool is enabled for CUs with size less than or equal to 64 in width and height. This maximum CU size for Intra template matching is configurable.

The Intra template matching prediction mode is signalled at CU level through a dedicated flag when DIMD (Decoder-side Intra Mode Derivation) is not used for current CU.

### IntraTMP Derived Block Vector Candidates for IBC

In this method, block vector (BV) derived from the intra template matching prediction (IntraTMP) is used for intra block copy (IBC). The stored IntraTMP BV of the neighbouring blocks along with IBC BV are used as spatial BV candidates in IBC candidate list construction.

IntraTMP block vector is stored in the IBC block vector buffer and, the current IBC block can use both IBC BV and IntraTMP BV of neighbouring blocks as BV candidates for IBC BV candidate list as shown in FIG. 3.

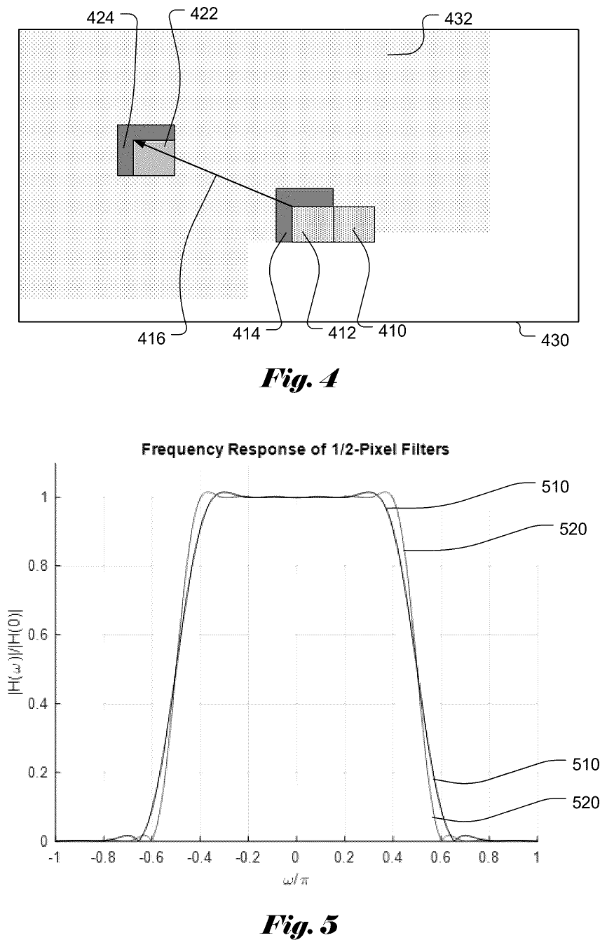

In FIG. 4, block 410 corresponds to the current block and block 412 corresponds to a neighbouring IntraTMP block. The IntraTMP BV 416 is used to locate the best matching block 422 according to the matching cost between template 424 and template 414. Area 422 corresponds to reconstructed region in the current picture 430. IntraTMP block vectors are added to IBC block vector candidate list as spatial candidates.

IBC Merge Mode with Block Vector Differences (IBC-MBVD)

Affine-MMVD (Merge mode with Motion Vector Difference) and GPM (Geometric Partition Mode)-MMVD have been adopted to ECM as an extension of regular MMVD mode. It is natural to extend the MMVD mode to the IBC merge mode.

In IBC-MBVD, the distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

The base candidates are selected from the first five candidates in the reordered IBC merge list. Based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions for consequent MBVD index coding. The MBVD index is binarized by the Rice code with the parameter equal to 1. An IBC-MBVD coded block does not inherit flip type from a RR-IBC coded neighbor block.

The 8-tap interpolation filter used in VVC is replaced with a 12-tap filter. The interpolation filter is derived from the sinc function, where the frequency response is cut off at Nyquist frequency and cropped by a cosine window function. Table 1 lists the filter coefficients of all 16 phases. FIG. 5 compares the frequency responses of the interpolation filters (520) with the VVC interpolation filter (510), at half-pel phase.

TABLE 1
Filter coefficients of the 12-tap interpolation filter

| | | | | | | | | | | | | |
|---|---|---|---|---|---|---|---|---|---|---|---|---|
| 1/16 | −1 | 2 | −3 | 6 | −14 | 254 | 16 | −7 | 4 | −2 | 1 | 0 |
| 2/16 | −1 | 3 | −7 | 12 | −26 | 249 | 35 | −15 | 8 | −4 | 2 | 0 |
| 3/16 | −2 | 5 | −9 | 17 | −36 | 241 | 54 | −22 | 12 | −6 | 3 | −1 |
| 4/16 | −2 | 5 | −11 | 21 | −43 | 230 | 75 | −29 | 15 | −8 | 4 | −1 |
| 5/16 | −2 | 6 | −13 | 24 | −48 | 216 | 97 | −36 | 19 | −10 | 4 | −1 |
| 6/16 | −2 | 7 | −14 | 25 | −51 | 200 | 119 | −42 | 22 | −12 | 5 | −1 |
| 7/16 | −2 | 7 | −14 | 26 | −51 | 181 | 140 | −46 | 24 | −13 | 6 | −2 |
| 8/16 | −2 | 6 | −13 | 25 | −50 | 162 | 162 | −50 | 25 | −13 | 6 | −2 |
| 9/16 | −2 | 6 | −13 | 24 | −46 | 140 | 181 | −51 | 26 | −14 | 7 | −2 |
| 10/16 | −1 | 5 | −12 | 22 | −42 | 119 | 200 | −51 | 25 | −14 | 7 | −2 |
| 11/16 | −1 | 4 | −10 | 19 | −36 | 97 | 216 | −48 | 24 | −13 | 6 | −2 |
| 12/16 | −1 | 4 | −8 | 15 | −29 | 75 | 230 | −43 | 21 | −11 | 5 | −2 |
| 13/16 | −1 | 3 | −6 | 12 | −22 | 54 | 241 | −36 | 17 | −9 | 5 | −2 |
| 14/16 | 0 | 2 | −4 | 8 | −15 | 35 | 249 | −26 | 12 | −7 | 3 | −1 |
| 15/16 | 0 | 1 | −2 | 4 | −7 | 16 | 254 | −14 | 6 | −3 | 2 | −1 |

For chroma interpolation additional longer 6-tap filters are used. The coefficients of filters are tabulated in Table 2.

TABLE 2
The coefficients of the 6-tap interpolation filter for chroma components.

| Fractional position | Coefficients (6 taps) |
|---|---|
| 1/32 | {0, 0, 256, 0, 0, 0}, |
| 2/32 | {1, −6, 256, 7, −2, 0}, |
| 3/32 | {2, −11, 253, 15, −4, 1}, |
| 4/32 | {3, −16, 251, 23, −6, 1}, |
| 5/32 | {4, −21, 248, 33, −10, 2}, |
| 6/32 | {5, −25, 244, 42, −12, 2}, |
| 7/32 | {7, −30, 239, 53, −17, 4}, |
| 8/32 | {7, −32, 234, 62, −19, 4}, |
| 6/32 | {8, −35, 227, 73, −22, 5}, |
| 7/32 | {9, −38, 220, 84, −26, 7}, |
| 8/32 | {10, −40, 213, 95, −29, 7}, |
| 9/32 | {10, −41, 204, 106, −31, 8}, |
| 10/32 | {10, −42, 196, 117, −34, 9}, |
| 11/32 | {10, −41, 187, 127, −35, 8}, |
| 12/32 | {11, −42, 177, 138, −38, 10}, |
| 13/32 | {10, −41, 168, 148, −39, 10}, |
| 14/32 | {10, −40, 158, 158, −40, 10}, |
| 15/32 | {10, −39, 148, 168, −41, 10}, |
| 16/32 | {10, −38, 138, 177, −42, 11}, |
| 17/32 | {8, −35, 127, 187, −41, 10}, |
| 18/32 | {9, −34, 117, 196, −42, 10}, |
| 19/32 | {8, −31, 106, 204, −41, 10}, |
| 20/32 | {7, −29, 95, 213, −40, 10}, |
| 21/32 | {7, −26, 84, 220, −38, 9}, |
| 22/32 | {5, −22, 73, 227, −35, 8}, |
| 23/32 | {4, −19, 62, 234, −32, 7}, |
| 24/32 | {4, −17, 53, 239, −30, 7}, |
| 25/32 | {2, −12, 42, 244, −25, 5}, |
| 26/32 | {2, −10, 33, 248, −21, 4}, |
| 27/32 | {1, −6, 23, 251, −16, 3}, |
| 28/32 | {1, −4, 15, 253, −11, 2}, |
| 31/32 | {0, −2, 7, 256, −6, 1}, |

### 4-Tap Interpolation Filter and Reference Sample Smoothing

Four-tap intra interpolation filters are utilized to improve the directional intra prediction accuracy. In HEVC, a two-tap linear interpolation filter has been used to generate the intra prediction block in the directional prediction modes (i.e., excluding Planar and DC predictors). In VVC, the two sets of 4-tap IFs replace lower precision linear interpolation as in HEVC, where one is a DCT-based interpolation filter (DCTIF) and the other one is a 4-tap smoothing interpolation filter (SIF). The DCTIF is constructed in the same way as the one used for chroma-component motion compensation in both HEVC and VVC. The SIF is obtained by convolving the 2-tap linear interpolation filter with [1 2 1]/4 filter.

Depending on the intra prediction mode, the following reference samples processing is performed:
The directional intra-prediction mode is classified into one of the following groups:
   Group A: vertical or horizontal modes (HOR-IDX, VER-IDX),
   Group B: directional modes that represent non-fractional angles (−14, −12, −10, −6, 2, 34, 66, 72, 76, 78, 80,) and Planar mode,
   Group C: remaining directional modes;
If the directional intra-prediction mode is classified as belonging to group A, then then no filters are applied to reference samples to generate predicted samples;
Otherwise, if a mode falls into group B and the mode is a directional mode, and all of following conditions are true, then a [1, 2, 1] reference sample filter may be applied (depending on the MDIS (Mode-Dependent Intra Smoothing) condition) to reference samples to further copy these filtered values into an intra predictor according to the selected direction, but no interpolation filters are applied:
   refIdx is equal to 0 (no MRL)
   TU size is greater than 32
   Luma
   No ISP block
Otherwise, if a mode is classified as belonging to group C, MRL index is equal to 0, and the current block is not ISP block, then only an intra reference sample interpolation filter is applied to reference samples to generate a predicted sample that falls into a fractional or integer position between reference samples according to a selected direction (no reference sample filtering is performed). The interpolation filter type is determined as follows:
   Set minDistVerHor equal to Min(Abs(predModeIntra−50), Abs(predModeIntra−18))
   Set nTbS equal to (Log 2(W)+Log 2(H))>>1
   Set intraHorVerDistThres[nTbS] as specified below:

| | nTbS = | nTbS = | nTbS = | nTbS = | nTbS = | nTbS = |
|---|---|---|---|---|---|---|
| | 2 | 3 | 4 | 5 | 6 | 7 |
| intraHorVerDistThres[ nTbS ] | 24 | 14 | 2 | 0 | 0 | 0 |

If minDistVerHor is greater than intraHorVerDistThres[nTbS], SIF is used for the interpolation
Otherwise, DCTIF is used for the interpolation
   Merge Mode with MVD (MMVD) in VVC

In addition to merge mode, where the implicitly derived motion information is directly used for prediction samples generation of the current CU, the merge mode with motion vector differences (MMVD) is introduced in VVC. An MMVD flag is signalled right after sending a regular merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The MMVD candidate flag is signalled to specify which one is used between the first and second merge candidates.

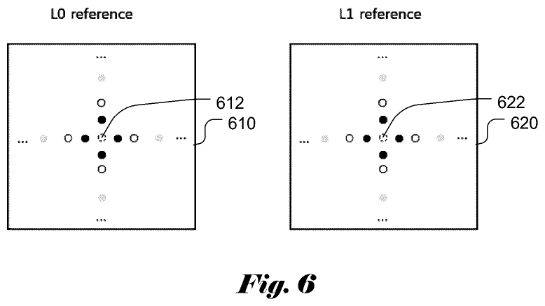

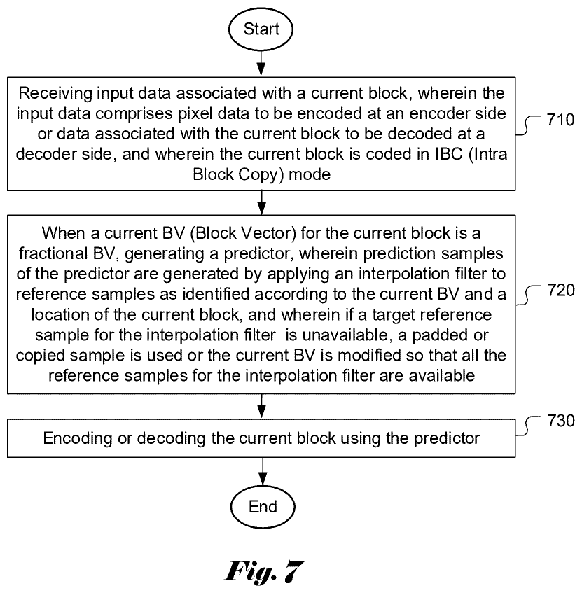

Distance index specifies motion magnitude information and indicates the pre-defined offset from a respective starting point (612 and 622) for a L0 reference block 610 and L1 reference block 620 as shown in FIG. 6. In FIG. 6, an offset is added to either horizontal component or vertical component of starting MV. The relation of distance index and pre-defined offset is specified in Table 3.

TABLE 3
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent one of the four directions as shown in Table 4. It's noted that the meaning of MVD sign can be variant according to the information of starting MVs. When the starting MVs is an un-prediction MV or bi-prediction MVs with both lists point to the same side of the current picture (i.e. POCs (Picture Order Counts) of two references being both larger than the POC of the current picture, or being both smaller than the POC of the current picture), the sign in Table 4 specifies the sign of MV offset added to the starting MV. When the starting MVs are bi-prediction MVs with the two MVs pointing to different sides of the current picture (i.e. the POC of one reference being larger than the POC of the current picture, and the POC of the other reference being smaller than the POC of the current picture), and the difference of POC in list 0 is greater than the one in list 1, the sign in Table 4 specifies the sign of MV offset added to the list0 MV component of starting MV and the sign for the list1 MV has an opposite value. Otherwise, if the difference of POC in list 1 is greater than list 0, the sign in Table 4 specifies the sign of MV offset added to the list1 MV component of starting MV and the sign for the list0 MV has an opposite value.

The MVD is scaled according to the difference of POCs in each direction. If the differences of POCs in both lists are the same, no scaling is needed. Otherwise, if the difference of POC in list 0 is larger than the one of list 1, the MVD for list 1 is scaled, by defining the POC difference of L0 as td and POC difference of L1 as tb. If the POC difference of L1 is greater than L0, the MVD for list 0 is scaled in the same way. If the starting MV is uni-predicted, the MVD is added to the available MV.

TABLE 4
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### Adaptive Motion Vector Resolution (AMVR) in VVC

In HEVC, motion vector differences (MVDs) between the motion vector and predicted motion vector of a CU are signalled in the unit of quarter-luma-sample when use_integer_mv_flag is equal to 0 in the slice header. In VVC, a CU-level adaptive motion vector resolution (AMVR) scheme is introduced. AMVR allows MVD of the CU to be coded in different precision. Depending on the mode (normal AMVP mode or affine AVMP mode) for the current CU, the MVDs of the current CU can be adaptively selected as follows:
Normal AMVP mode: quarter-luma-sample, half-luma-sample, integer-luma-sample or four-luma-sample.
Affine AMVP mode: quarter-luma-sample, integer-luma-sample or 1/16 luma-sample.

The CU-level MVD resolution indication is conditionally signalled if the current CU has at least one non-zero MVD component. If all MVD components (i.e., both horizontal and vertical MVDs for reference list L0 and reference list L1) are zero, quarter-luma-sample MVD resolution is inferred.

For a CU that has at least one non-zero MVD component, a first flag is signalled to indicate whether quarter-luma-sample MVD precision is used for the CU. If the first flag is 0, no further signaling is needed and quarter-luma-sample MVD precision is used for the current CU. Otherwise, a second flag is signalled to indicate that half-luma-sample or other MVD precisions (integer or four-luma sample) are used for normal AMVP CU. In the case of half-luma-sample, a 6-tap interpolation filter instead of the default 8-tap interpolation filter is used for the half-luma sample position. Otherwise, a third flag is signalled to indicate whether integer-luma-sample or four-luma-sample MVD precision is used for normal AMVP CU. In the case of affine AMVP CU, the second flag is used to indicate whether integer-luma-sample or 1/16 luma-sample MVD precision is used. In order to ensure the reconstructed MV has the intended precision (quarter-luma-sample, half-luma-sample, integer-luma-sample or four-luma-sample), the motion vector predictors for the CU will be rounded to the same precision as that of the MVD before being added together with the MVD. The motion vector predictors are rounded toward zero (i.e., a negative motion vector predictor rounded toward positive infinity and a positive motion vector predictor rounded toward negative infinity).

The encoder determines the motion vector resolution for the current CU using RD (Rate-Distortion) check. To avoid always performing CU-level RD check four times for each MVD resolution, in VTM (Versatile Video Coding and Test Model), the RD check of MVD precisions other than quarter-luma-sample is only invoked conditionally. For normal AVMP mode, the RD cost of quarter-luma-sample MVD precision and integer-luma sample MV precision is computed first. Then, the RD cost of integer-luma-sample MVD precision is compared to that of quarter-luma-sample MVD precision to decide whether it is necessary to further check the RD cost of four-luma-sample MVD precision. When the RD cost for quarter-luma-sample MVD precision is much smaller than that of the integer-luma-sample MVD precision, the RD check of four-luma-sample MVD precision is skipped. Then, the check of half-luma-sample MVD precision is skipped if the RD cost of integer-luma-sample MVD precision is significantly larger than the best RD cost of previously tested MVD precisions. For affine AMVP mode, if affine inter mode is not selected after checking rate-distortion costs of affine merge/skip mode, merge/skip mode, quarter-luma-sample MVD precision normal AMVP mode and quarter-luma-sample MVD precision affine AMVP mode, then 1/16 luma-sample MV precision and 1-pel MV precision affine inter modes are not checked. Furthermore, affine parameters obtained in quarter-luma-sample MV precision affine inter mode is used as starting search point in 1/16 luma-sample and quarter-luma-sample MV precision affine inter modes.

### JVET-Y0067 EE2-3.9 and EE2-3.10: TM Based Reordering for MMVD and Affine MMVD and MVD Sign Prediction

In JVET-Y0067 (Mehdi Salehifar, et al., “EE2-3.9 and EE2-3.10: TM based reordering for MMVD and affine MMVD and MVD sign prediction”, Joint Video Experts Team (JVET) of ITU-T SG 16 WP 3 and ISO/IEC JTC 1/SC 29, 25th Meeting, by teleconference, 12-21 Jan. 2022, Document: JVET-Y0067), template matching based reordering for MMVD and affine MMVD and MVD sign prediction are disclosed. The technique disclosed in JVET-Y0067 is described as follows.

In JVET-X0085 (Mehdi Salehifar, et al., “Non-EE2: Template Matching-based Reordering for Extended MMVD Design”, Joint Video Experts Team (JVET) of ITU-T SG 16 WP 3 and ISO/IEC JTC 1/SC 29, 24th Meeting, by teleconference, 6-15 Oct. 2021, Document: JVET-X0085), a template matching based reordering method for extended MMVD is proposed which improves the coding gain of MMVD and affine MMVD.

In JVET-X0132 (Yan Zhang, et al., “Non-EE2: On MVD sign prediction”, Joint Video Experts Team (JVET) of ITU-T SG 16 WP 3 and ISO/IEC JTC 1/SC 29, 24th Meeting, by teleconference, 6-15 Oct. 2021, Document: JVET-X0132), MVD sign is predicted, and context coded based on the template matching cost. The conversion from EP coding to context-based coding improves coding efficiency of MVD sign.

In JVET-Y0067, extension of MMVD/affine MMVD and MVD sign prediction are tested per the description of EE2 3.9 and 3.10.

In EE2 3.9a, JVET-Y0067 first proposes to add additional refinement positions along k×π/8 diagonal angles thus increasing the number of directions from 4 to 16. Second, based on the SAD cost between the template (one row above and one column left to the current block) and its reference for each refinement position, all the possible MMVD refinement positions (16×6) are reordered for each base candidate according to JVET-Y0067. Finally, the top ⅛ refinement positions with the smallest template SAD costs are kept as available positions, consequently for MMVD index coding. The MMVD index is binarized by the Rice code with the parameter equal to 2.

In EE2 3.9b, on top of the 3.9a, JVET-Y0067 also proposes to add extended affine MMVD reordering in which additional refinement positions along k×π/4 diagonal angles are added. After reordering top ½ refinement positions with the smallest template SAD costs are kept.

In EE2 3.10, MVD sign prediction method is tested. With this method, possible MVD sign combinations are sorted according to template matching cost and index corresponding to the true MVD sign is derived and coded with context model. At the decoder side, the MVD signs are derived as following:
1. Parse the magnitude of MVD components.
2. Parse context-coded MVD sign prediction index.
3. Build MV candidates by creating combination between possible signs and absolute MVD value and add it to the MV predictor.
4. Derive MVD sign prediction cost for each derived MV based on template matching cost and sort.
5. Use MVD sign prediction index to select the true MVD sign.

MVD sign prediction is applied to inter AMVP, affine AMVP, MMVD and affine MMVD modes. In EE2 3.9c, a joint test of EE2 3.9a and EE2 3.10 is performed, where the MMVD extension method used in EE2 3.9a is used to replace the MMVD MVD sign prediction part in EE2 3.10.

In EE2 3.9d, a joint test of EE2 3.9b and EE2 3.10 is performed, where both the MMVD extension and affine MMVD extension methods used in EE2 3.9b are used to replace the MMVD and affine MMVD MVD sign prediction parts in EE2 3.1.

### JVET-AC0104 EE2-3.3: Block Vector Difference Prediction for IBC Blocks

In JVET-AC0104 ( ), a method is proposed to apply sign prediction to BVD and to further extend this approach for predicting suffix bins of BVD magnitudes. Suffix bins are also derived at the decoder side by comparing values of signalled bins with the bins of the best candidates obtained with template matching. The maximum number of bins to be predicted for a PU is controlled by a macro. By setting this macro, we investigate 4 configurations that corresponds the 4 sub-tests where the following number of BVD bins are predicted:
Test EE2-3.3a: up to 2 BVD signs and 4 BVD suffix bins;
Test EE2-3.3b: up to 2 BVD signs and 6 BVD suffix bins;
Test EE2-3.3c: up to 2 BVD signs and 8 BVD suffix bins; and
Test EE2-3.3d: up to 2 BVD signs and 10 BVD suffix bins.

The most significant bins of magnitude suffixes of BVD horizontal and vertical components are predicted, and the prediction match result is coded in the bitstream using CABAC context mode. The less significant bins of magnitude suffixes of horizontal and vertical BVD components are coded in by-pass mode.

In order to improve the performance for systems using IBC and/or IntraTMP, several new techniques are proposed for Intra Block Copy (IBC) mode and Intra Template Matching (IntraTMP) mode, including interpolation filter design, adaptive BV resolution, merge with BVD (MBVD) and BVD prediction.

### Filter Design in IBC Mode and IntraTMP Mode

In the proposed method, fractional BV is allowed in IBC mode and IntraTMP mode. To generate fractional reference samples pointed by a fractional BV, interpolation filter will be utilized. The interpolation filter can be the same as the interpolation filter in inter-prediction mode or the interpolation filter in intra-prediction mode, or different interpolation filters from other prediction modes. The taps of interpolation filter in IBC mode and IntraTMP mode can be the same as in inter-prediction mode or intra-prediction mode, or different from other prediction modes. Switchable interpolation filter may apply to IBC mode and IntraTMP mode. The interpolation filters for the luma component can be the same as in the interpolation filters for the luma component in inter-prediction or in intra-prediction, or different from other prediction modes. The interpolation filters for chroma components can be the same as in the interpolation filters for chroma components in inter-prediction or in intra-prediction, or different from other prediction modes.

In one embodiment, interpolation filters used in IBC mode or IntraTMP mode are the same as the interpolation filters used in inter-prediction mode.

In another embodiment, interpolation filters used in IBC mode or IntraTMP mode are the same as the interpolation filters used in intra-prediction mode.

In another embodiment, interpolation filters used in IBC mode or IntraTMP mode are different from the interpolation filters used in inter-prediction mode or intra-prediction mode.

In another embodiment, interpolation filters used in IBC mode or IntraTMP mode are 2-taps or 4-taps or 6-taps or 8-taps or 10-taps or 12-taps or 14-taps or 2N-taps, where N is an integer larger than or equal to 0.

In another embodiment, different interpolation filters coefficients are used in IBC mode or IntraTMP mode when BV resolution is changed or different from other BV resolutions. For example, when BV resolution is half-pel, different taps of interpolation filter or different interpolation filter coefficients are used accordingly.

In another embodiment, different interpolation filters taps are used in IBC mode or IntraTMP mode when BV resolution is changed or different from other BV resolutions.

In another embodiment, different reference regions for the interpolation filter are used when BV resolution is changed or different from other BV resolutions.

In another embodiment, interpolation filters for the luma component in IBC mode or IntraTMP mode are the same as the interpolation filters for the luma component in inter-prediction mode.

In another embodiment, interpolation filters for chroma component in IBC mode or IntraTMP mode are the same as the interpolation filters for chroma components in inter-prediction mode.

In another embodiment, interpolation filters for the luma component in IBC mode or IntraTMP mode are the same as the interpolation filters for the luma component in intra-prediction mode.

In another embodiment, interpolation filters for chroma components in IBC mode or IntraTMP mode are the same as the interpolation filters for chroma components in intra-prediction mode.

In another embodiment, interpolation filters for the luma component in IBC mode or IntraTMP mode are different from the interpolation filters for the luma component in inter-prediction mode or in intra-prediction mode.

In another embodiment, interpolation filters for chroma components in IBC mode or IntraTMP mode are different from the interpolation filters for chroma components in inter-prediction mode or intra-prediction mode.

### Adaptive BV Resolution in IBC Mode and IntraTMP Mode

In this method, multiple BV resolutions or adaptive BV resolutions are allowed in IBC mode and IntraTMP mode. The multiple BV resolutions or adaptive BV resolutions may follow the AMVR design in VVC, or different from the AMVR design in VVC. The BVD precision for storage, signalling or derivation may be the same as the BV resolution or BV precision, or different from BV resolution or BV precision. The multiple BV resolutions or adaptive BV resolutions may apply to merge mode, AMVP mode, GPM mode, CIIP (Combined Intra-Inter Prediction) mode, LIC (Local Illumination Compensation) mode, subblock mode, affine mode and other prediction modes. To determine BV resolution of current blocks, some high-level syntax or flags can be utilized.

In one embodiment, the multiple BV resolutions or adaptive BV resolutions are the same as in AMVR in VVC design. For example, BV resolution may include 1/16-pel, ¼-pel, ½-pel, full-pel and 4-pel.

In another embodiment, the fractional BV precision is considered in adaptive BV resolutions.

In another embodiment, the multiple BV resolutions or adaptive BV resolutions are different from AMVR in VVC design. For example, only some coarse BV resolutions are considered, such as full-pel and 4-pel. In another example, only finer BV resolutions are considered, such as 1/16-pel and ¼-pel.

In another embodiment, the BVD precision for storage, signalling or derivation for the current block is the same as the BV resolution or BV precision of the current block. For example, when the current block uses 4-pel BV precision, BVD precision is also 4-pel.

In another embodiment, the BVD precision for storage, signalling or derivation for the current block can be different from the BV resolution or BV precision of the current block. For example, when the current block uses 4-pel BV precision, BVD precision can be in 4-pel precision or other precisions.

In another embodiment, the multiple BV resolutions or adaptive BV resolutions may be applied to merge modes and its sub-modes or other related or combined modes, such as AMVP-merge mode, GPM mode, CIIP mode.

In another embodiment, the multiple BV resolutions or adaptive BV resolutions may be applied to AMVP modes and its sub-modes or other related or combined modes, such as AMVP-merge mode.

In another embodiment, the multiple BV resolutions or adaptive BV resolutions may be applied to subblock modes and its sub-modes or other related or combined modes, such as, affine modes or SbTMVP mode.

In another embodiment, when neighbouring blocks use adaptive BV resolutions, the current block can also implicitly use adaptive BV resolutions.

In another embodiment, when reordering is performed, the candidates with same BV resolution are grouped together and reordering is performed within each group.

In another embodiment, when reordering is performed, the candidates are reordered regardless of different BV precisions.

In another embodiment, a CU-level flag or CTU-level flag, picture-level flag or sequence-level flag is signalled to determine whether the current block uses multiple BV resolutions or adaptive BV resolutions or not.

In another embodiment, whether the current block uses multiple BV resolutions or adaptive BV resolutions or not is determined implicitly.

In another embodiment, whether the current block uses multiple BV resolutions or adaptive BV resolutions or not depends on some conditions, including but not limited to, information related to block size, block motion, block flags, neighbouring blocks, statistical data, etc.

### BVD Prediction in Adaptive BV Resolutions in IBC Mode and IntraTMP Mode

In the proposed method, when BVD prediction is enabled, multiple BV resolutions or adaptive BV resolutions may or may not be applied. When BVD prediction is applied, fractional BV may be considered.

In one embodiment, BVD prediction is applied when fractional BV is allowed in IBC mode and IntraTMP mode.

In another embodiment, when BVD prediction and multiple BV resolutions, or BVD prediction and adaptive BV resolutions are both applied to the current block, multiple BV resolutions or adaptive BV resolutions is performed firstly to determine BV precision and BVD precision, then BVD sign prediction is performed to determine the sign value and BVD suffix.

In another embodiment, when BVD prediction and multiple BV resolutions or adaptive BV resolutions are both applied to the current block, BVD sign prediction is performed to determine the sign value and BVD suffix firstly, and then multiple BV resolutions or adaptive BV resolutions is performed to determine BV precision and BVD precision.

In another embodiment, when BVD prediction and multiple BV resolutions or BVD prediction and adaptive BV resolutions are both applied to the current block, when BV resolutions are finer (i.e., use finer precision like 1/16-pel), the number of suffix prediction in BVD can be reduced.

In another embodiment, when BVD prediction and multiple BV resolutions or BVD prediction and adaptive BV resolutions are both applied to the current block, when BV resolutions are finer (i.e., use finer precision like 1/16-pel), the number of suffix prediction in BVD can be increased.

In another embodiment, when BVD prediction and multiple BV resolutions or BVD prediction and adaptive BV resolutions are both applied to the current block, when BV resolutions are coarser (i.e., use coarser precision like 4-pel), the number of suffix prediction in BVD can be increased.

In another embodiment, when BVD prediction and multiple BV resolutions or BVD prediction and adaptive BV resolutions are both applied to the current block, when BV resolutions are coarser (i.e., use coarser precision like 4-pel), the number of suffix prediction in BVD can be decreased.

### BVD Prediction in Multiple BVs in IBC and IntraTMP Mode

In the proposed method, when multiple BVs or multiple predictors are allowed in IBC mode and IntraTMP mode, BVD prediction can be applied.

In one embodiment, when BVD prediction is applied to the current block, multiple BV resolutions or adaptive BV resolutions is disabled at the current block.

In another embodiment, BVD prediction and multiple BV resolutions or adaptive BV resolutions are mutually exclusive.

In another embodiment, when multiple BVs and BVD prediction are both applied, BVD prediction is applied to BVD of each BV separately.

In another embodiment, when multiple BVs and BVD prediction are both applied, BVD prediction is applied to one or more BVs only, the other BVs do not perform BVD prediction.

In another embodiment, when multiple BVs and BVD prediction are both applied, BVD prediction is applied to BVD of partial BVs, such as only horizontal or vertical BV component.

In another embodiment, when multiple BVs and BVD prediction are both applied, BVD prediction reorders only some BVD or BVD signs partially.

In another embodiment, when multiple BVs and BVD prediction are both applied, BVD prediction only derives some suffix partially.

### BVD Prediction and Interpolation Filter Design and Adaptive BV Resolutions in Affine Mode and Subblock Mode in IBC Mode and IntraTMP Mode

In the proposed method, when affine mode or subblock mode is allowed in IBC mode and IntraTMP mode, BVD prediction can be applied. Multiple BV resolutions, adaptive BV resolutions or fractional BV may also apply. Interpolation filter affine mode and subblock mode in IBC mode and IntraTMP mode can be derived from other prediction modes or different from other prediction modes, such as AMVP mode or merge mode.

In one embodiment, when it is bi-prediction affine mode or subblock mode in IBC mode and IntraTMP mode, BVD prediction is applied to L0 and L1 prediction separately.

In another embodiment, when it is bi-prediction affine mode or subblock mode in IBC mode and IntraTMP mode, BVD prediction is applied to each predicted-direction predictor separately.

In another embodiment, when it is affine mode or subblock mode in IBC mode and IntraTMP mode, BVD prediction is applied to one or more CP (Control Point)-BVD.

In another embodiment, when it is affine mode or subblock mode in IBC mode and IntraTMP mode, BVD prediction is applied to reorder CP-BVDs partially. The proposed method can be applied to single predictor or multiple predictor cases.

In another embodiment, when it is affine mode or subblock mode in IBC mode and IntraTMP mode, BVD prediction is applied but only some sign combinations are performed to reorder BVD. The proposed method can be applied to single predictor or multiple predictor cases.

In another embodiment, when it is affine mode or subblock mode in IBC mode and IntraTMP mode, fractional BV or fractional CP-BV or fractional BVD or fractional CP-BVD is allowed.

In another embodiment, when it is affine mode or subblock mode in IBC mode and IntraTMP mode, when it performs predictor generation or motion compensation, the number of taps in interpolation filters used can be less. For example, normally in IBC predictor generation or motion compensation uses 12-taps. In affine mode or subblock, the number of taps can be less than 12-taps, such as 10-taps.

In another embodiment, when it is affine mode or subblock mode in IBC mode and IntraTMP mode, when it performs predictor generation or motion compensation, the number of taps in interpolation filters used can be more. For example, normally in IBC predictor generation or motion compensation is 8-taps. In affine mode or subblock, the number of taps can be more than 8-taps, such as 10-taps.

In another embodiment, when it is affine mode or subblock mode in IBC mode and IntraTMP mode, when it performs predictor generation or motion compensation, the number of taps in interpolation filters used for luma component or chroma components can be derived from other prediction modes. For example, interpolation filter used in affine mode and subblock mode can be from normal IBC predictor generation or motion compensation but with some coefficients merged.

In another embodiment, the multiple BV resolutions or adaptive BV resolutions is the same as in affine AMVR in VVC design. For example, BV resolution includes from 1/16-pel, ¼-pel, ½-pel, full-pel and 4-pel.

In another embodiment, the fractional BV precision in affine mode and subblock mode is considered in adaptive BV resolutions.

In another embodiment, the multiple BV resolutions or adaptive BV resolutions is different from affine AMVR in VVC design. For example, only some coarse BV resolutions are considered, such as full-pel and 4-pel. In another example, only finer BV resolutions are considered, such as 1/16-pel and ¼-pel.

In another embodiment, the BVD precision for storage, or signalling or derivation for the current block is the same as the BV resolution or BV precision of the current block in affine mode or subblock mode. For example, when the current block uses 4-pel BV precision, BVD precision is also 4-pel.

In another embodiment, the BVD precision for storage, or signalling or derivation for the current block can be different from the BV resolution or BV precision of the current block in affine mode or subblock mode. For example, when the current block uses 4-pel BV precision, BVD precision can be in 4-pel precision or other precisions.

In another embodiment, multiple BV resolutions or adaptive BV resolutions may be applied to affine merge modes and its sub-modes or other related or combined modes, such as AMVP-merge mode, GPM mode, CIIP mode.

In another embodiment, the multiple BV resolutions or adaptive BV resolutions may be applied to affine AMVP modes and its sub-modes or other related or combined modes, such as AMVP-merge mode.

In another embodiment, when neighbouring blocks use adaptive BV resolutions, the current block in affine mode or subblock mode can also implicitly use adaptive BV resolutions.

In another embodiment, when reordering is performed, the candidates with same BV resolution are grouped together and reordering is performed within each group in affine mode or subblock mode.

In another embodiment, when reordering is performed, the candidates are reordered regardless of different BV precisions in affine mode or subblock mode.

In another embodiment, a CU-level flag, CTU-level flag or picture-level flag or sequence-level flag is signalled to determine whether the current block in affine mode or subblock mode uses multiple BV resolutions or adaptive BV resolutions or not.

In another embodiment, whether the current block in affine mode or subblock mode uses multiple BV resolutions or adaptive BV resolutions or not is determined implicitly.

In another embodiment, whether the current block in affine mode or subblock mode uses multiple BV resolutions or adaptive BV resolutions or not depends on some conditions, including but not limited to, block size info, block motion info, block flags info, neighbouring blocks info, statistical data, etc.

In another embodiment, subblock or affine mode in IBC or IntraTMP and adaptive BV resolution are mutually exclusive.

In another embodiment, when the current block is subblock mode or affine mode in IBC mode or IntraTMP mode, BV precision or BV resolution is the same for whole subblocks inside in block.

In another embodiment, possible BV resolutions in AMVP mode are different from affine mode or subblock mode in IBC mode or IntraTMP mode. For example, possible BV resolutions in affine mode or subblock mode can be less than the possible BV resolutions in AMVP mode.

In another embodiment, possible BV resolutions in AMVP mode are different from affine mode or subblock mode in IBC mode or IntraTMP mode. For example, possible BV resolutions in affine mode or subblock mode can be more than the possible BV resolutions in AMVP mode.

### IBC-MBVD and Adaptive BV Resolutions in IBC Mode and IntraTMP Mode

In the proposed method, when IBC-MBVD is applied, adaptive BV resolutions and fractional BV may also apply.

In one embodiment, when IBC-MBVD is applied, fractional-pel precision is also considered in the distance.

In another embodiment, when IBC-MBVD is applied in inter-slices or inter-pictures, MBVD derivation method is the same as MMVD derivation method.

In another embodiment, when IBC-MBVD is applied in inter-slices or inter-pictures, MBVD derivation method is different from MMVD derivation method.

In another embodiment, when IBC-MBVD is applied in intra-slices or intra-pictures, MBVD derivation method is the same as MMVD derivation method.

In another embodiment, when IBC-MBVD is applied in intra-slices or intra-pictures, MBVD derivation method is different from MMVD derivation method.

In another embodiment, when IBC-MBVD is applied, only partial MBVD refinement positions are reordered.

In another embodiment, when IBC-MBVD is applied, only fractional-pel MBVD refinement positions are reordered.

In another embodiment, when IBC-MBVD is applied, only integer-pel MBVD refinement positions are reordered, even if BV resolution is in fractional precision.

In another embodiment, when IBC-MBVD is applied, only coarser MBVD refinement positions are reordered when BV resolution is in coarser precision.

In another embodiment, when IBC-MBVD is applied, only finer MBVD refinement positions are reordered when BV resolution is in coarser precision.

In another embodiment, when IBC-MBVD is applied, only coarser MBVD refinement positions are reordered when BV resolution is in finer precision.

In another embodiment, when IBC-MBVD is applied, only finer MBVD refinement positions are reordered when BV resolution is in finer precision.

In another embodiment, when IBC-MBVD and adaptive BV resolutions are both applied, when BV is in coarser precision, larger MBVD offsets are considered firstly.

In another embodiment, when IBC-MBVD and adaptive BV resolutions are both applied, when BV is in coarser precision, smaller MBVD offsets are considered firstly.

In another embodiment, when IBC-MBVD and adaptive BV resolutions are both applied, when BV is in finer precision, larger MBVD offsets are considered firstly.

In another embodiment, when IBC-MBVD and adaptive BV resolutions are both applied, when BV is in finer precision, smaller MBVD offsets are considered firstly.

In another embodiment, flag indicating BV resolutions is signalled firstly and then flag indicating IBC-MBVD is signalled afterwards.

In another embodiment, flag indicating IBC-MBVD is signalled firstly and then flag indicating BV resolutions is signalled afterwards.

In another embodiment, when IBC-MBVD and adaptive BV resolutions are both applied, BV resolution is firstly determined, then IBC-MBVD is performed based on the derived BV resolution.

In another embodiment, when IBC-MBVD and adaptive BV resolutions are both applied, IBC-MBVD is firstly performed, then BV resolution is determined based on the determined MBVD distance.

In another embodiment, the MBVD distance offset is signalled, then the distance offset resolution is signalled. The final step in MBVD is derived based on distance offset and distance offset resolution.

In another embodiment, the MBVD distance offset is signalled and the distance offset resolution is implicitly derived. The final step in MBVD is derived based on distance offset and distance offset resolution.

In another embodiment, the MBVD distance offset is implicitly derived and the distance offset resolution is signalled. The final step in MBVD is derived based on distance offset and distance offset resolution.

In another embodiment, both MBVD distance offset and the distance offset resolution are implicitly derived. The final step in MBVD is derived based on distance offset and distance offset resolution.

To increase the flexibility of intraTMP, several techniques to signal high level flags to indicate the specific behaviour of intraTMP are disclosed.

### Adaptive Motion Vector Resolution

In one embodiment, fractional motion resolution can be applied during the intraTMP searching process in some cases. For example, if the current sequence is not screen content, both integer-pel and half-pel motion resolutions are tested; and the best motion position is selected for the final prediction. If the current sequence is screen content, only integer-pel motion resolution can be applied.

In another embodiment, whether to use fractional-pel motion resolution in the searching process can be determined by a high-level flag.

In one embodiment, a flag can be signalled in Sequence Parameter Set (SPS) or Picture Parameter Set (PPS) and it is used to indicate whether fractional-pel resolution is allowed for intraTMP or not. In another embodiment, a flag (e.g. ph_frac_intraTMP_enabled, sh_frac_intraTMP_enabled) can be signalled in picture header or slice header.

In another embodiment, a higher level syntax, (e.g. sps_frac_intraTMP_enabled, or pps_frac_intraTMP_enabled) is signaled. Only if it is true, the lower level related syntax (e. g. ph_frac_intraTMP_enabled, sh_frac_intraTMP_enabled) can be signalled. Additionally, if the related syntax, (e.g. ph_frac_intraTMP_enabled) is signalled in picture header, the related syntax signalled in slice header (e.g. sh_frac_intraTMP_enabled) will not be signalled. In other words, only if the related syntax (e.g. ph_frac_intraTMP_enabled) is not present in picture header, the related syntax in slice header (e.g. sh_frac_intraTMP_enabled) can be signalled.

In one embodiment, the interpolation filter used in fractional-pel resolution of intraTMP can be determined by high level syntaxes. For example, sps_frac_interpolation_filter_index or pps_frac_interpolation_filter_index is signalled. For another example, only if sps_frac_intraTMP_enabled, or pps_frac_intraTMP_enabled is true, sps_frac_interpolation_filter_index or pps_frac_interpolation_filter_index can be signalled. For another example, only if sps_frac_intraTMP_enabled, or pps_frac_intraTMP_enabled is true, ph_frac_interpolation_filter_index or sh_frac_interpolation_filter_index can be signalled. For another example, only if sps_frac_interpolation_filter_index, or pps_frac_interpolation_filter_index is not signalled, ph_frac_interpolation_filter_index or sh_frac_interpolation_filter_index can be signalled.

In one embodiment, sps_frac_interpolation_filter_index, pps_frac_interpolation_filter_index, ph_frac_interpolation_filter_index or sh_frac_interpolation_filter_index equal to 0, means 8-tap interpolation filter is used. In another embodiment, sps_frac_interpolation_filter_index, pps_frac_interpolation_filter_index, ph_frac_interpolation_filter_index or sh_frac_interpolation_filter_index equal to 1, means 4-tap interpolation filter is used. In another embodiment, sps_frac_interpolation_filter_index, pps_frac_interpolation_filter_index, ph_frac_interpolation_filter_index or sh_frac_interpolation_filter_index equal to 2 (means bilinear interpolation filter) is used. For another example, only if ph_frac_intraTMP_enabled, or sh_frac_intraTMP_enabled is true, ph_frac_interpolation_filter_8 or sh_frac_interpolation_filter_8 can be signalled. ph_frac_interpolation_filter_8 or sh_frac_interpolation_filter_8 equal to 1, means 8-tap interpolation filter is used. ph_frac_interpolation_filter_8 or sh_frac_interpolation_filter_8 equal to 0, means 4-tap interpolation filter is used.

intraTMP Fusion

In one embodiment, fusion can be applied on intraTMP. For example, if the current sequence is not screen content, during the searching process, two prediction blocks are found corresponding to the best and second-best TM costs; and the final predictor can be derived by fusion of the two prediction blocks. If current sequence is screen content, fusion technology of intraTMP will be disabled.

In another embodiment, whether to use fusion technology on intraTMP can be determined by a high-level flag.

In one embodiment, a flag can be signalled in Sequence Parameter Set (SPS) or Picture Parameter Set (PPS), and it is used to indicate whether fusion technology is allowed for intraTMP. In another embodiment, a flag can be signalled in picture header or slice header, such as ph_fusion_intraTMP_enabled and sh_fusion_intraTMP_enabled.

In another embodiment, a higher level syntax, such as sps_fusion_intraTMP_enabled, or pps_fusion_intraTMP_enabled is signalled. Only if it is true, the lower level related syntax, such as ph_fusion_intraTMP_enabled or sh_fusion_intraTMP_enabled, can be signalled. Additionally, if the related syntax, such as ph_fusion_intraTMP_enabled, is signalled in picture header, the related syntax signalled in slice header (e.g. sh_fusion_intraTMP_enabled) will not be signalled. In other words, only if the related syntax (e.g. ph_fusion_intraTMP_enabled) is not present in picture header, the related syntax in slice header (e.g. sh_fusion_intraTMP_enabled) can be signalled.

Filtered Template Matching based Intra Prediction (FTMP)

To improve the prediction accuracy of intraTMP, a filter is applied to adapt the characteristics of the copied block to the local neighbourhood.

In one embodiment, a higher level syntax is used to control the on-off of filtered template matching based intra prediction, such as sps_fusion_intraTMP_enabled or pps_fusion_intraTMP_enabled. In another embodiment, a flag can be signalled in picture header or slice header, such as ph_filtered_intraTMP_enabled or sh_filtered_intraTMP_enabled. In another embodiment, a higher level syntax, such as sps_filtered_intraTMP_enabled or pps_filtered_intraTMP_enabled is signalled. Only if it is true, the lower level related syntax, such as ph_filtered_intraTMP_enabled or sh_filtered_intraTMP_enabled, can be signalled. Additionally, if the related syntax, such as ph_filtered_intraTMP_enabled, is signalled in picture header, the related syntax signalled in slice header (e.g. sh_filtered_intraTMP_enabled) will not be signalled. In other words, only if the related syntax (e.g. ph_filtered_intraTMP_enabled) is not present in picture header, the related syntax in slice header (i.e. sh_filtered_intraTMP_enabled) can be signalled.

### IBC

All the above-mentioned technology can be applied on Intra Block Copy Mode (IBC). In some applications, fractional motion resolution, fusion technology or filtered prediction can be applied on IBC. Furthermore, the on-off can be determined by a high-level flag, such as SPS flags, PPS flags, PH flags, or SH flags.

To improve the coding efficiency of IBC, methods to apply fractional motion precision to IBC are disclosed.

### Method of Fractional IBC Refinement

In one embodiment, a fractional motion TM refinement is applied to a BVP after IBC merge list or AMVP list generation, where the precision can be half-pel or quarter-pel.

In another embodiment, the TM cost of fractional refined BVPs can be used to reorder IBC merge list or IBC AMVP list.

In another embodiment, after integer TM refinement and reordering of IBC merge list or AMVP list, a fractional motion TM refinement is applied to N best candidates in the list to further refine BVs. N can be any integer larger than 0.

In another embodiment, the integer TM costs can be stored during the TM refinement stage, and after that, parametric error surface equation can be used to further refine BVPs in fractional motion precision. For example, quarter-pel can be applied.

In another embodiment, either fractional TM refinement or parametric error surface equation is used to refine IBC BVPs. The selection can be determined by integer TM costs.

In another embodiment, fractional TM refinement and parametric error surface equation are sequentially applied.

In another embodiment, more reference samples are required during performing the interpolation due to using fractional BV. If the reference samples are not in the available region, the padded samples or copied samples are used instead. In another example, the BV is modified to make sure all the reference samples are available.

In one embodiment, the IBC or intraTMP only needs to signal or search the BV in integer sample precision, and perform the fractional search before sample compensation (e.g., generating predictors). The fractional search can use template matching or error surface. The refined fractional part of the BV can be stored and used to update the BV, or be discarded (e.g., only used for generating predictors and not storing the fractional part).

In another, the interpolation can be replaced by calculating the intensity delta values derived by gradient value multiplied by the delta BV (e.g., fractional part of BV).

In another embodiment, the IBC BV signalling is still under integer BV precision, but the IBC merge mode, which may include IBC MMVD, IBC CIIP, IBC GPM, IBC LIC) and/or intraTMP, can still apply the fractional BV refinement. When doing this, the BV without adding delta BV can have higher priority (e.g., lower cost factor when BV not modified). In one example, a high-level syntax can be signalled to indicate whether the fractional refinement can be applied to IBC and/or intraTMP or not. In another example, the IBC BV signalling can be signalled at most to 1/N (e.g., quarter-pel) precision, and the fractional BV refinement can be refined to 1/M (e.g., 1/16-pel) precision, where the M>=N.

High-Level On-Off Control of IBC with Fractional Refinement

In one embodiment, a higher-level syntax is used to control the on-off of fractional BV refinement on IBC, such as sps_frac_ibc_enabled or pps_frac_ibc_enabled. In another embodiment, a flag can be signalled in picture header or slice header, such as ph_frac_ibc_enabled and sh_frac_enabled_enabled. In another embodiment, a higher level syntax, such as sps_frac_ibc_enabled or pps_frac_ibc_enabled is signalled. Only if it is true, the lower level related syntax, such as ph_frac_ibc_enabled or sh_frac_ibc_enabled, can be signalled. Additionally, if the related syntax, such as ph_frac_ibc_enabled, is signalled in picture header, the related syntax signalled in slice header (e.g. sh_frac_ibc_enabled) will not be signalled. In other words, only if the related syntax (e.g. ph_frac_ibc_enabled) is not present in picture header, the related syntax in slice header (e.g. sh_frac_ibc_enabled) can be signalled.

In another embodiment, the on-off of fractional BV refinement on IBC is determined by a hash hit rate. Only if a hash hit rate is larger than a pre-defined threshold, IBC with fractional BV refinement can be enabled.

In another embodiment, a flag specifying that the merge mode with motion vector difference uses only integer sample precision for the current picture can be used to determine the on-off of fractional BV refinement.

In another embodiment, the usage of fractional TM refinement or parametric error surface equation can be determined by a high-level flag.

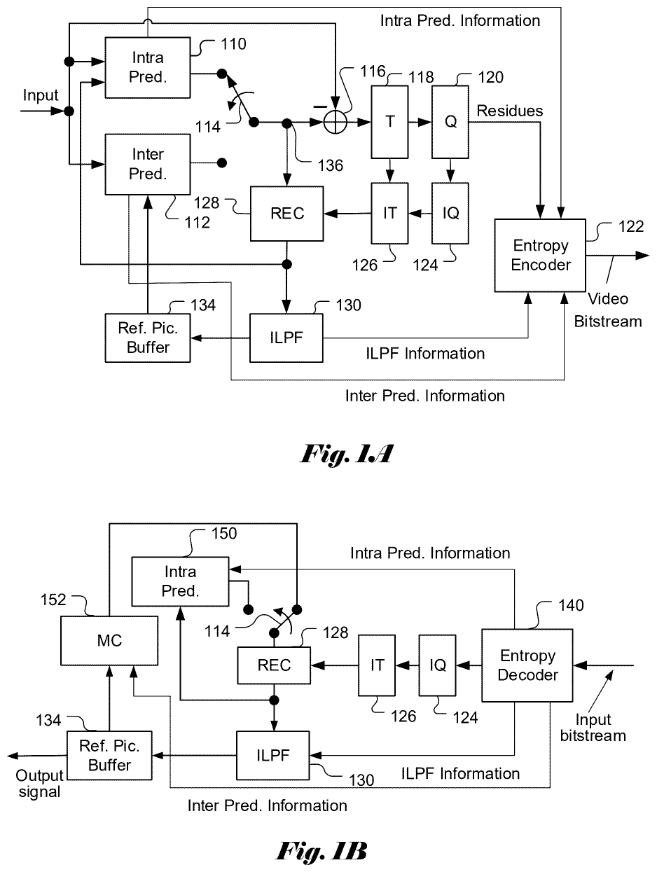

The fractional BV precision for IBC and/or IntraTMP as described above can be implemented in an encoder side or a decoder side. For example, any of the proposed fractional BV precision processing or signalling method can be implemented in an Intra/Inter coding module (e.g. Intra Pred. 150/MC 152 in FIG. 1B) in a decoder or an Intra/Inter coding module is an encoder (e.g. Intra Pred. 110/Inter Pred. 112 in FIG. 1A) or any other separate model to perform IBC and/or IntraTMP in a decoder side or encoder side. Any of the proposed shared buffer to store coding information among multiple coding tools including the CCM mode can also be implemented as a circuit coupled to the intra/inter coding module at the decoder or the encoder. However, the decoder or encoder may also use additional processing unit to implement the required cross-component prediction processing. While the Intra Pred. units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

FIG. 7 illustrates a flowchart of an exemplary video coding system that uses fractional block vector precision for IBC and/or IntraTMP according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to the method, input data associated with a current block are received in step 710, wherein the input data comprises pixel data to be encoded at an encoder side or data associated with the current block to be decoded at a decoder side, and wherein the current block is coded in IBC (Intra Block Copy) mode. When a current BV (Block Vector) for the current block is a fractional BV, a predictor is generated in step 720, wherein prediction samples of the predictor are generated by applying an interpolation filter to reference samples as identified according to the current BV and a location of the current block, and wherein if a target reference sample for the interpolation filter is unavailable, a padded or copied sample is used or the current BV is modified so that all the reference samples for the interpolation filter are available. The current block is encoded or decoded using the predictor in step 730.

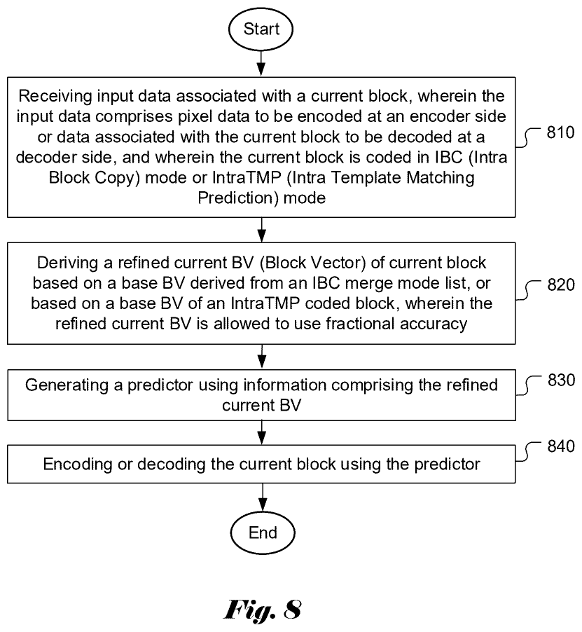

FIG. 8 illustrates a flowchart of another exemplary video coding system that uses fractional block vector precision for IBC and/or IntraTMP according to an embodiment of the present invention. According to another method, input data associated with a current block are received in step 810, wherein the input data comprises pixel data to be encoded at an encoder side or data associated with the current block to be decoded at a decoder side, and wherein the current block is coded in IBC (Intra Block Copy) mode or IntraTMP (Intra Template Matching Prediction) mode. A refined current BV (Block Vector) of current block is derived based on a base BV derived from an IBC merge mode list, or based on a base BV of an IntraTMP coded block in step 820, wherein the refined current BV is allowed to use fractional accuracy. A predictor is generated using information comprising the refined current BV in step 830. The current block is encoded or decoded using the predictor in step 840.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprises pixel data to be encoded at an encoder side or data associated with the current block to be decoded at a decoder side, and wherein the current block is coded in IBC (Intra Block Copy) mode;
when a current BV (Block Vector) for the current block is a fractional BV, generating a predictor, wherein prediction samples of the predictor are generated by applying an interpolation filter to reference samples as identified according to the current BV and a location of the current block, and wherein if a target reference sample for the interpolation filter is unavailable, a padded or copied sample is used or the current BV is modified so that all the reference samples for the interpolation filter are available; and
encoding or decoding the current block using the predictor.

2. An apparatus for video coding, the apparatus comprising one or more electronics or processors arranged to:
receive input data associated with a current block, wherein the input data comprises pixel data to be encoded at an encoder side or data associated with the current block to be decoded at a decoder side, and wherein the current block is coded in IBC (Intra Block Copy) mode;
when a current BV (Block Vector) for the current block is a fractional BV, generate a predictor, wherein prediction samples of the predictor are generated by applying an interpolation filter to reference samples as identified according to the current BV and a location of the current block, and wherein if a target reference sample for the interpolation filter is unavailable, a padded or copied sample is used or the current BV is modified so that all the reference samples for the interpolation filter are available; and
encode or decode the current block using the predictor.

3. A method of video coding, the method comprising:
receiving input data associated with a current block, wherein the input data comprises pixel data to be encoded at an encoder side or data associated with the current block to be decoded at a decoder side, and wherein the current block is coded in IBC (Intra Block Copy) mode or IntraTMP (Intra Template Matching Prediction) mode;
deriving a refined current BV (Block Vector) of current block based on a base BV derived from an IBC merge mode list, or based on a base BV of an IntraTMP coded block, wherein the refined current BV is allowed to use fractional accuracy;
generating a predictor using information comprising the refined current BV; and
encoding or decoding the current block using the predictor.

4. The method of claim 3, wherein the IBC merge mode list is associated with IBC MBVD (Merge with BV Difference) mode, IBC CIIP (Combined Intra-Inter Prediction) mode, IBC GPM (Geometric Partition Mode) mode, or IBC LIC (Local Illumination Compensation) mode.

5. The method of claim 3, wherein a high-level syntax is signalled or parsed, wherein high-level syntax indicates whether the fractional accuracy is applied to the IBC, the intraTMP mode or both.

6. The method of claim 3, wherein a finest accuracy of the base BV signalled or parsed corresponds to 1/N-pel luma sample and N is one positive integer.

7. The method of claim 6, wherein N corresponds to 1 or 4.

8. The method of claim 6, wherein a finest fractional accuracy of the refined BV corresponds to 1/M-pel luma sample and M is one positive integer greater than or equal to N.

9. The method of claim 8, wherein M corresponds to 16.

10. The method of claim 3, wherein the base BV in the IBC merge mode list without a delta BV has a higher priority compared with the refined BV with a delta BV derived from the base BV.

11. The method of claim 3, wherein multiple BV resolutions or adaptive BV resolutions are applied to the current block, a first flag is signalled or parsed to indicate whether IBC-MBVD is used for the current block and a second flag is signalled or parsed to indicate BV resolutions.

12. The method of claim 3, wherein when IBC-MBVD (Merge with BV Difference) is applied to inter-slices or inter-pictures, MBVD derivation method is the same as MMVD (Merge mode with Motion Vector Difference) derivation method.

13. The method of claim 3, wherein when IBC-MBVD (Merge with BV Difference) is applied to the current block, only finer MBVD refinement positions are reordered when BV resolution belongs to a finer precision.

14. An apparatus for video coding, the apparatus comprising one or more electronics or processors arranged to:
receive input data associated with a current block, wherein the input data comprises pixel data to be encoded at an encoder side or data associated with the current block to be decoded at a decoder side, and wherein the current block is coded in IBC (Intra Block Copy) mode or IntraTMP (Intra Template Matching Prediction) mode;
derive a refined current BV (Block Vector) of current block based on a base BV derived from an IBC merge mode list, or based on a base BV of an IntraTMP coded block, wherein the refined current BV is allowed to use fractional accuracy;
generate a predictor according to the refined current BV; and
encode or decode the current block using the predictor.
